(19) United States
(12) Patent Application Publication
(10) Pub. No.: US 2011/0181797 A1
(43) Pub. Date: Jul. 28, 2011

(54) WAFER-LEVEL FABRICATION OF LIQUID CRYSTAL OPTOELECTRONIC DEVICES

(75) Inventors: Tigran Galstian, Quebec (CA); Derek Alexandre Proudian, Palo Alto, CA (US); Behram Afshari, Los Altos, CA (US); Michael J. Nystrom, San Jose, CA (US); Peter Clark, Boxborough, MA (US)

(73) Assignee: LENSVECTOR INC., Mountain View, CA (US)

(21) Appl. No.: 13/061,336

(22) PCT Filed: Sep. 1, 2009
(86) PCT No.: PCT/CA2009/001181

§ 371 Date: Feb. 28, 2011

Related U.S. Application Data
(60) Provisional application No. 61/093,419, filed on Sep. 1, 2008.

(51) Int. Cl. G02F 1/1335

(52) U.S. Cl. 349/2; 349/84

(57) ABSTRACT

Liquid crystal optoelectronic devices are produced by fabricating a wafer-level component structure and affixing a plurality of discrete components to a surface structure prior to singulating the individual devices therefrom. After singulation, the individual devices include a portion of the wafer-level fabricated structure and at least of the discrete components. The wafer-level structure may include a liquid crystal and controlling electrodes, and the discrete components may include fixed lenses or image sensors. The discrete components may be located on either or both of two sides of the wafer-level structure. Multiple liquid crystal layers may be used to reduce nonuniformities in the interaction with light from different angles, and to control light of different polarizations. The liquid crystal devices may function as optoelectronic devices such as tunable lenses, shutters or diaphragms.

### FIELD OF THE INVENTION

The present invention relates to the field of optoelectronic devices and their fabrication using wafer level fabrication techniques.

### BACKGROUND OF THE INVENTION

In the field of image sensors, photodetectors, light emitting diodes and other optoelectronic devices, it is known to use a carrier substrate, such as a glass or plastic plate, to which an array of optoelectronic devices are bonded and then “singulated” into individual chips. It is also known to add filters or lens structures to a planar substrate by way of etching, injection molding or deposition so as to provide a wafer with an array of optical devices that can be bonded to their optoelectronic devices and singulated into individual devices. Fabrication of such devices as a wafer makes manufacture more efficient for a number of reasons, some of which are processing of the wafer is much faster than processing of individual components, and testing of the components can be done faster for the array while on the wafer than after singulation. The use of a carrier substrate allows for the wafer to be handled as a single item of a relatively large size. This is faster and easier than handling individual chips having small dimensions that make such handling difficult.

Some references of interest are U.S. Pat. No. 7,245,834 to Vigier-Blanc that illustrates wafer fabrication of an optoelectronic device with a lens over each device, U.S. Pat. No. 6,627,864 to Glenn et al that describes wafer fabrication of an image sensor package including an optical aperture window, and U.S. Pat. No. 7,329,861 to Ma et al that describes an integrally packaged imaging module that describes providing arrays of lenses over individual image sensors in a wafer array.

### SUMMARY OF THE INVENTION

In accordance with the present invention, a tunable liquid crystal optical device is provided for which wafer level fabrication is used to form a structure having a liquid crystal layer from which a plurality of devices may be singulated, and discrete components are affixed to the wafer prior to singulation such that the singulated devices each include one or more additional components. The present invention thus provides a substrate for the discrete components that is an active optoelectronic structure allowing the formation of complex optoelectronic devices at the wafer stage that are singulated from a functional layered substrate combined with desired discrete external components.

The invention includes a method of making a plurality of liquid crystal optical devices by first fabricating a layered, wafer-level component structure. This wafer-level structure includes a liquid crystal layer and a plurality of electrode layers for applying an electric field to the liquid crystal layer. A plurality of optical components are affixed to a surface of the component structure, each in a different predetermined location of the surface. Predetermined regions of the component structure are then separated so as to singulate the plurality of optical devices therefrom, such that each of the optical devices includes a portion of the wafer-level fabricated structure and at least one of the optical components affixed thereto.

The liquid crystal layer may be operated as any of a number of different optoelectronic devices, such as a tunable lens, a shutter or a variable diaphragm. The wafer-level component structure, and therefore the finished optical devices, may include multiple liquid crystal layers, each with liquid crystal molecules having a different alignment angle, so as to minimize non-uniformities in the interaction with light originating from different angular directions. The wafer-level component structure may also include multiple individually controllable liquid crystal devices, each having at least one liquid crystal layer and at least one electrode. An optical device resulting from such a structure might be desirable if, for example, each of the liquid crystal layers acted upon a different polarization of light.

The optical components affixed to the surface of the wafer-level component structure may include fixed lenses, image sensors, a combination of the two, or other components altogether. The components may also be affixed to one or both of two different surfaces of the wafer-level component structure. For example, fixed lenses might be affixed to the structure on both a first surface and a second surface such that a finished singulated optical device includes a fixed lens on either side (each side corresponding to one of the primary surfaces of the wafer-level component structure). Similarly, fixed lenses may be affixed to a first surface, while image sensors are affixed to a second surface, such that the singulated devices include a fixed lens on one side of the device and an image sensor on the other side. The singulated devices in such a case may therefore require only minor finishing additions, such as electrical leads, to be functional as focusable camera devices.

### BRIEF DESCRIPTION OF THE DRAWINGS

FIG. 1 is a schematic illustration (not to scale) showing a side view of a wafer-fabricated, singulated, four liquid crystal layer variable optical power lens embedded in a flat substrate to which plano-convex lenses are added to each surface.

FIG. 2 is a schematic top view of the embodiment of FIG. 1 showing the orientation of light polarization and rubbing directions.

FIG. 3 is a schematic side view of a wafer structure equivalent to one half of the tunable liquid crystal lens (TLCL) of FIG. 1.

FIG. 4 is a schematic top view of the embodiment of FIG. 3. For simplicity of illustration, only four cells are shown in the two-by-two array on the wafer.

FIG. 5 illustrates schematically the bonding of image sensors to a substrate having an embedded liquid crystal optical device.

FIG. 6 illustrates schematically an embodiment in which the liquid crystal optical device substrate carrying lens structures on its surfaces is mounted with an imaging sensor carrying substrate also having a liquid crystal optical device embedded therein.

FIG. 7 illustrates schematically an embodiment in which an electric field modulating layer of the structure is located between two liquid crystal structures.

### DETAILED DESCRIPTION

The present invention relates to electrically controllable liquid crystal optical devices, such as those described in the following international patent applications, the subject matter of which is incorporated herein by reference: PCT Application No. PCT/CA2009/000743; PCT Application No. PCT/IB2009/052658; PCT Application No. PCT/CA2009/000742. Each of these earlier applications describes liquid crystal structures that may be suitable for the type of fabrication described herein. Moreover, those skilled in the art will recognize that this fabrication process may be equally applied to other structures as well.

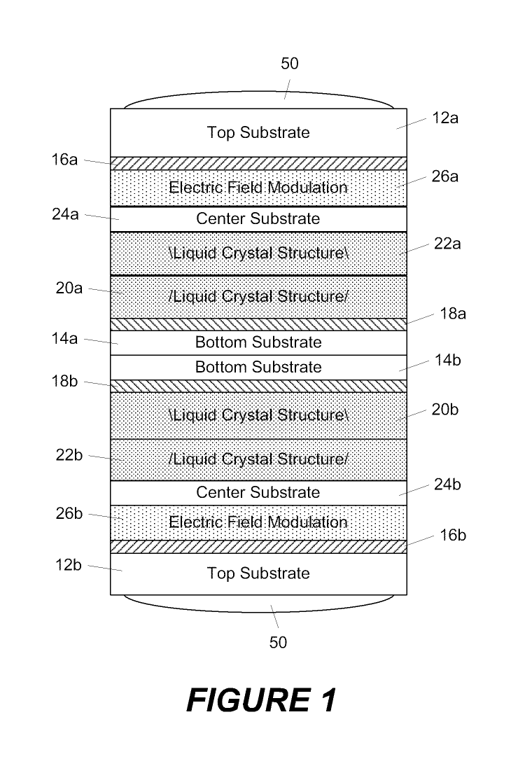

Shown in FIG. 1 is a tunable liquid crystal lens (TLCL) structure fabricated in accordance with the present invention. This structure includes two TLCL half wafers fixed together, the two wafers having a rotation of ninety degrees relative to each other, such that each half TLCL operates on a different polarization of light. Each half, however, is otherwise identical, and identical components of the two halves are therefore represented using the same reference numeral, but with a different letter identifier, the letter “a” representing a first TLCL half, and the letter “b” representing a second TLCL half. In the description herein, the use of a reference numeral in discussing either of the TLCL halves without specifying the “a” or “b” suffix is intended to refer equally to both TLCL halves.

The structure of FIG. 1 is a wafer fabricated device having two halves, each of which includes a top substrate 12, a bottom substrate 14, conductive layers 16, 18 liquid crystal structures 20, 22, center substrate 24 and electric field modulation layer 26. The use of two liquid crystal structures 20, 22 in each half, each LC structure having a different crystal alignment, compensates for the non-uniform response that would result if a single layer were used, due to the different interaction of the liquid crystals with light originating from different directions. It should be understood that, while shown schematically in FIG. 1, the lens structures 20, 22 each include not just a liquid crystal, but also additional multiple materials necessary to support the liquid crystal layers, including one or more substrates between the lens structures 20, 22. Each of the two halves of the TLCL of FIG. 1 also has integrated thereupon a fixed lens structure that operates in conjunction with the TLCL portion of the device. The fixed lens structure may be any type of desired lens, including a positive or negative lens or a lens for correcting aberration or other ray propagation issues. As discussed below, other components instead of, or in addition to, the fixed lens may also be affixed to the wafer structure as part of the fabricated device.

The wafer level fabrication process of the present invention may be understood in conjunction with FIG. 3, which shows a first embodiment of two adjacent TLCL devices fabricated as part of a single wafer. Those skilled in the art will understand that a typical wafer will include more, and typically many more, than two devices, and that the configuration of FIG. 3 is for illustrative purposes. The fabrication process starts with a bare glass substrate, namely, bottom substrate 32. The glass used for the substrates of the device is typically a borosilicate glass which is manufactured in very thin thicknesses, 100 microns or less. The glass is cleaned using processes recommended by the glass manufacturer. These include a combination of detergent soaks, ultrasonic cleaning, and deionized water rinses. The clean glass is then coated with a transparent conductive thin film electrode 34. Typically, this electrode is an indium tin oxide which is sputter deposited, although other thin film deposition techniques, such as evaporation, may also be used. It may be desired to use a patterned electrode for this lower electrodes, and to obtain a patterned electrode the conductive electrode 34 may be deposited through a shadow mask, where the areas not to be coated are blocked by a metal mask.

The next step is to fabricate the liquid crystal (LC) cell. The bottom substrate 32 and center substrate 36, which is also a glass wafer, form the upper and lower support surfaces for the LC cell, and are coated with an alignment layer (for the bottom substrate 32 this coating is on top of the electrode layer 34). The coating layer is not shown in the figure but, as known in the art, serves to align the liquid crystal molecules in a common, predetermined orientation. Typically, this will result in a surface with some microscopic texture. The coating layer may be a polyimide layer which is later textured by rubbing with a cloth or may be an oxide film which is deposited in a manner which results in a highly textured surface.

After the textured surface is formed, the cell itself is fabricated. In an exemplary embodiment, three materials are deposited on one of the glass wafers that form the LC cell, and these materials are shown collectively in FIG. 3 as the liquid crystal structure 38. The first material is any additional conducting material. This is often a conductive adhesive or solder. A nonconducting adhesive is also deposited to define the area to be filled with liquid crystal material. Nonconductive adhesives are typically acrylic, epoxy, or silicone materials. Finally, the liquid crystal material is deposited. In one or more of the materials deposited, spacers are included. The spacers are typically glass or polymer spheres of a tightly controlled size which act to set the thickness of the LC cell. Finally the second glass wafer (e.g., the center substrate 36) is placed on top of the dispensed materials and the adhesive materials are cured using heat, pressure, and/or light. Those skilled in the art will understand that this is just one specific example of the liquid crystal cell, and that the invention applies equally to liquid crystal cells having other materials and/or configurations.

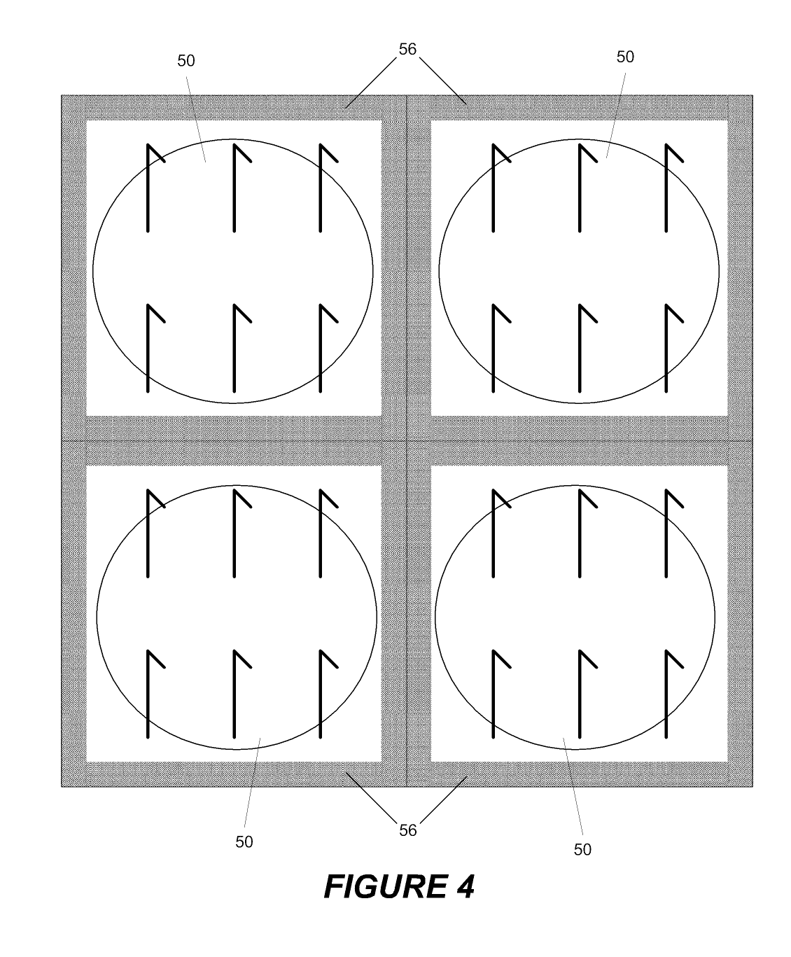

In the next step, electric field spatial modulating (electric field “lens”) structure 40 is fabricated on a third glass wafer, namely, top substrate 42, on which has already been coated an electrode layer 44. As with the electrode layer 34 of the bottom substrate, the electrode 44 of the top substrate may be patterned if desired. Possible electrode contacts are also shown in FIG. 3. The modulating structure 40 applied to the top substrate is typically fabricated from polymer layers with varying electrical and optical properties. Alternatively, patterned electrodes and complex conductivity materials can be used alone or in combination to provide the desired electric field spatial modulation. For example, in one embodiment, the electric field modulation layer includes a predetermined distribution of frequency-dependent permittivity material that results in a desired spatial distribution of electric field strength. Such frequency-dependent materials may be used alone or in combination with patterned electrodes. In some embodiments, the electric field need not be spatially modulated due to the nature and purpose of the liquid crystal device. Additional conductive materials (such as conductive adhesives and solders) and structural material (such as glass, polymer, or metal spacers) may be incorporated. After being fabricated, the top substrate 42 electrode coating 44 and electric field modulation layer 40 are bonded to the LC cell using an optical adhesive material. At this point, a TLCL has been fabricated that is effective for one polarization of light. However, as discussed below, this structure may represent just one half of a TLCL fabricated in wafer form, as another such structure may be added to create a TLCL that works with both orthogonal polarizations of light. FIG. 4 is a top view of the structure of FIG. 3, with indications of the single polarization direction addressed by the liquid crystal layers (FIG. 4 shows four potential devices of the wafer but, as mentioned above, an actual wafer-level fabrication would typically include many more such structures).

Creating a non-polarization sensitive TLCL involves bonding two half TLCL wafers together. The two wafers are placed with their bottom substrates back to back, as is shown in FIG. 1. In addition, one wafer is rotated 90 degrees relative to the other, so that the alignment of the LC cells in each half TLCL is at 90 degrees to each other. Each half TLCL acts on one polarization of light, and the combination of the two polarization orientations allows for the TLCL to operate without polarization dependence. An optical adhesive is placed between the two wafers and the wafers are aligned such that the optical axes of the individual devices in each wafer are aligned. The optical adhesive is then cured using heat, pressure and/or light.

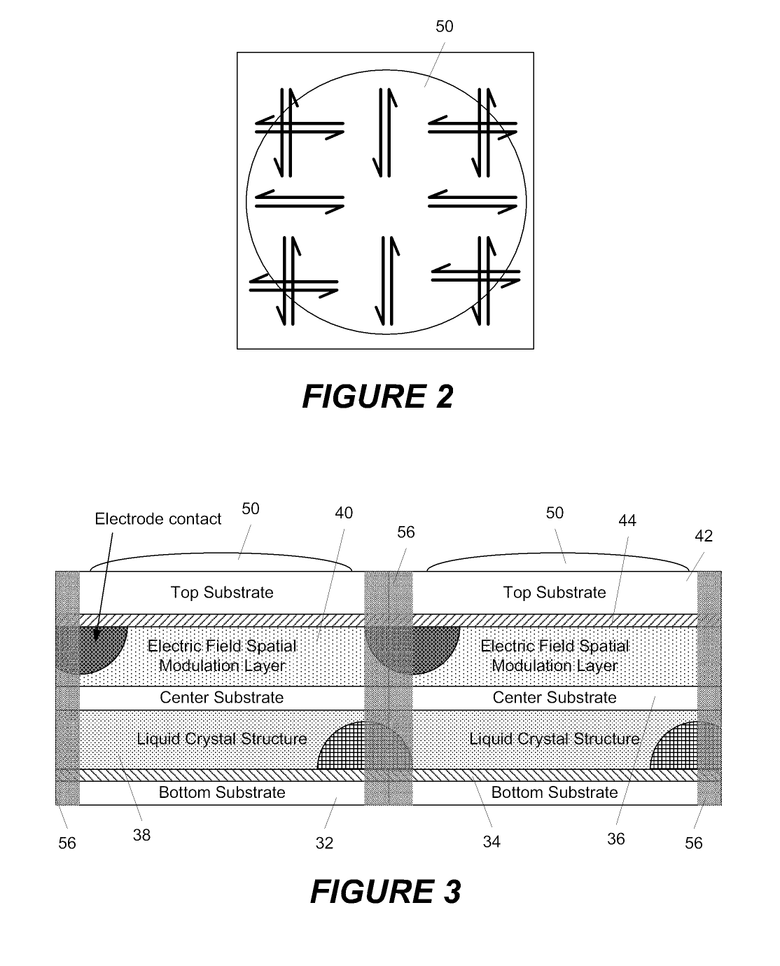

Liquid crystal molecules interact with light differently as a function of orientation with respect to the direction of light propagation. Therefore the optical property of the liquid crystal is different as a function of angle of incidence on the TLCL. To reduce this effect, each half TLCL can alternatively contain two layers, namely each one with its alignment layer having its directors pointing at the same angle but in an opposite direction to the other. In this way, each half TLCL is less dependent on the angle of incidence of light. Such a configuration is shown in the embodiment of FIG. 1. Thus, in this embodiment, the TLCL wafer has a total of four embedded liquid crystal layers. This is also indicated in FIG. 2, which is a top view representation of the embodiment of FIG. 1, including indications of the resulting polarization in orthogonal axes with the split cells providing liquid crystal orientation in both directions along each axis. In the embodiment illustrated in FIG. 3, the half TLCL has only one LC layer, and so the corresponding top view in FIG. 4 indicates a single orientation direction.

The half TLCL wafer and/or the full TLCL has sufficient mechanical strength to be used as a carrier substrate for receiving a lens coating (or having a lens etched in the glass substrate) on the top substrate. In the embodiment of FIGS. 1 to 4, a plano-convex lens is provided on the top substrate of each half TLCL, such that in combination on the full TLCL, a convex lens is provided. For example, in the embodiment of FIG. 3, a plano-convex lens 50 is fixed to the top substrate 42 of the structure adjacent to each separate TLCL unit to be singulated from the wafer structure. The use of a fixed lens with a liquid crystal lens structure may provide certain advantages depending on the application, such as the ability to control the electrically adjustable range of the TLCL within a particular range of optical powers. Thus, in an embodiment such as this, the fixed lens 50 is integrated as part of the wafer-level fabrication, thereby allowing the mass production of TLCL units that include this feature. The location of a fixed lens 50 on each half of the TLCL provides similar advantages in the structure of FIG. 1.

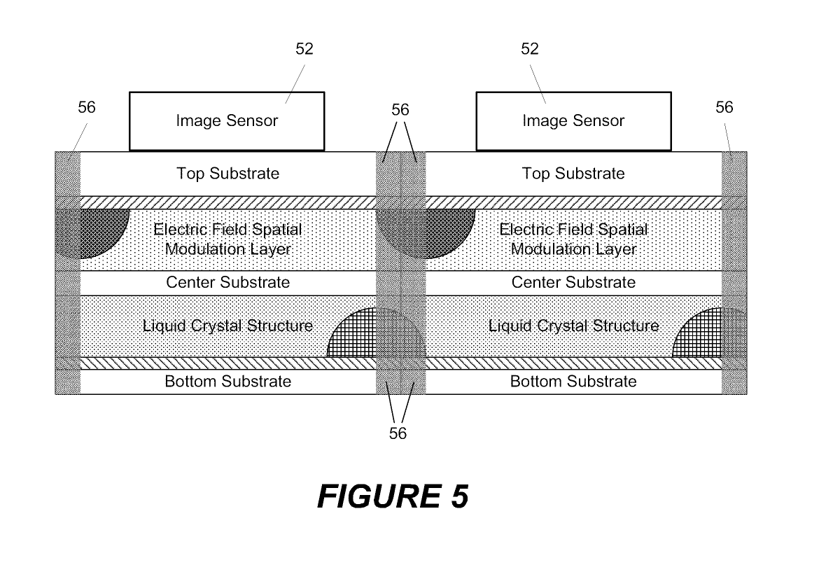

In the embodiment of FIG. 5, a TLCL structure is shown that is like that of the FIG. 3 embodiment except that, rather than a fixed lens, an image sensor 52 is integrated into each of the TLCL units. The TLCL units are fabricated on the wafer level, as described above in conjunction with FIG. 3, but an image sensor 52 is bonded to a surface of each unit. The surface may be a surface of the top substrate 42, and may be positioned at an appropriate distance from the rest of the structure to allow detection of an image focused by the liquid crystal lens.

While the liquid crystal optical device embedded in the wafer substrate of the embodiments shown is a variable optical power lens, it will be appreciated that a planar liquid crystal optical device can be a fixed lens without being electrically controllable. This can be particularly useful for making optoelectronic assemblies, such as light emitters and detectors to be coupled to optical fibers and other waveguides. Such liquid crystal lenses may be programmed and fixed (cured) to have specific optical properties, such as optical power and aberrations, that may differ from part to part. Wafers of such “programmed” layers may be joined to the arrays of other wafer level elements, such as injection molded (or otherwise made) lens or image sensor arrays. In this way, the “programmed” wafer may be used to correct another more costly array of lenses of cameras.

The liquid crystal optical device can also be a controllable device for providing controllable beam steering, polarization filtering, shutter functions or a variable aperture diaphragm (equivalent to an iris). In the case of a shutter or an iris diaphragm, the optical device can use non-liquid crystal materials to provide a thin, non-mechanical device. For example, it is known from Japanese patent publication 2004-12906 to provide an electrophoretic device that causes migration of opaque particles in an annular geometry to dilate and restrict an iris aperture.

In addition to conventional liquid crystal devices, a “once programmable material” can be placed between thin glass plates and used to provide a fixed optical device, such as a lens. A good example of an application of this is to correct the Chief Ray Angle. In such a case, the embedded optical device can be used to correct imperfections detected in the whole optical assembly at the appropriate stage of manufacturing, for example prior to singulation. An example of a once programmable material is a reactive mesogene material that can be programmed using an electric or magnetic field and then set using a chemical or radiation initiator.

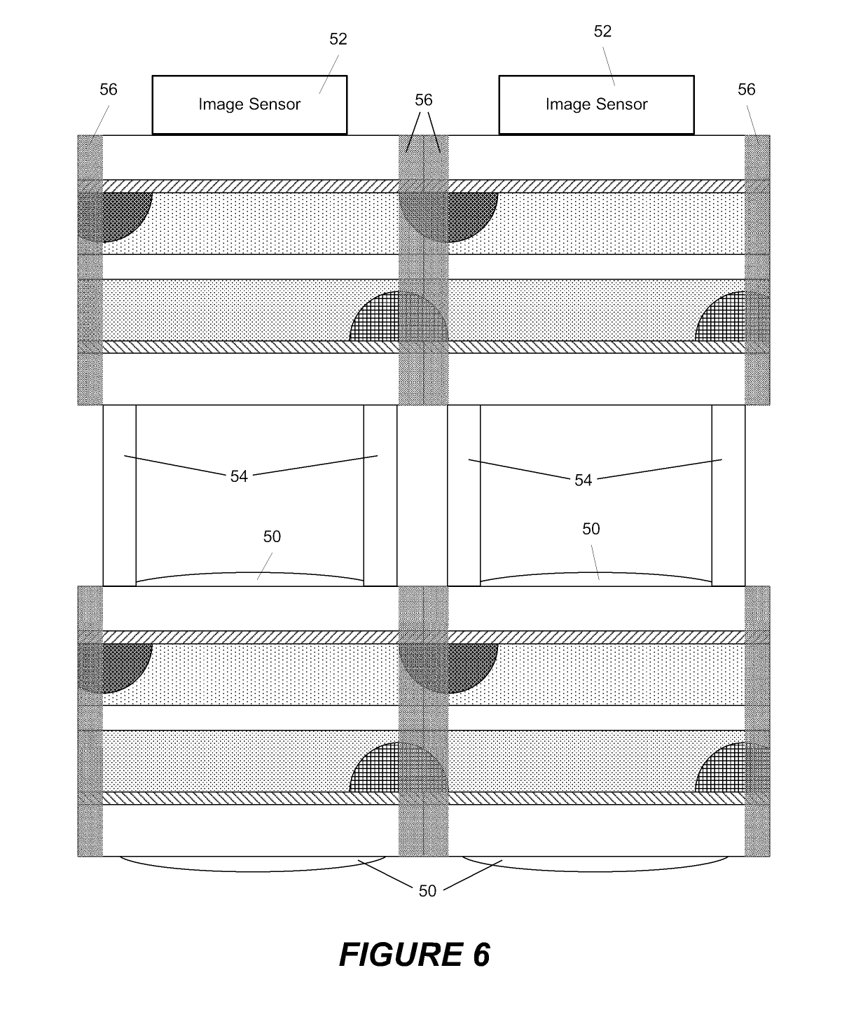

In FIG. 6, two wafer substrates having embedded liquid crystal optical devices are mounted together in a stack. One wafer has image sensors 52 bonded to one side. The associated liquid crystal optical device may be a shutter or variable polarization filter. Depending upon the type of the electrically variable device, the distance of the image sensor from that device must be appropriately chosen. The second wafer is mounted by a spacer structure 54 to the first wafer, and the second wafer has tunable lenses embedded therein and is also combined with plano-convex lenses 50 for providing the desired base optical power for focusing an image on the image sensor. The tunable lens can thus provide a focus adjustment.

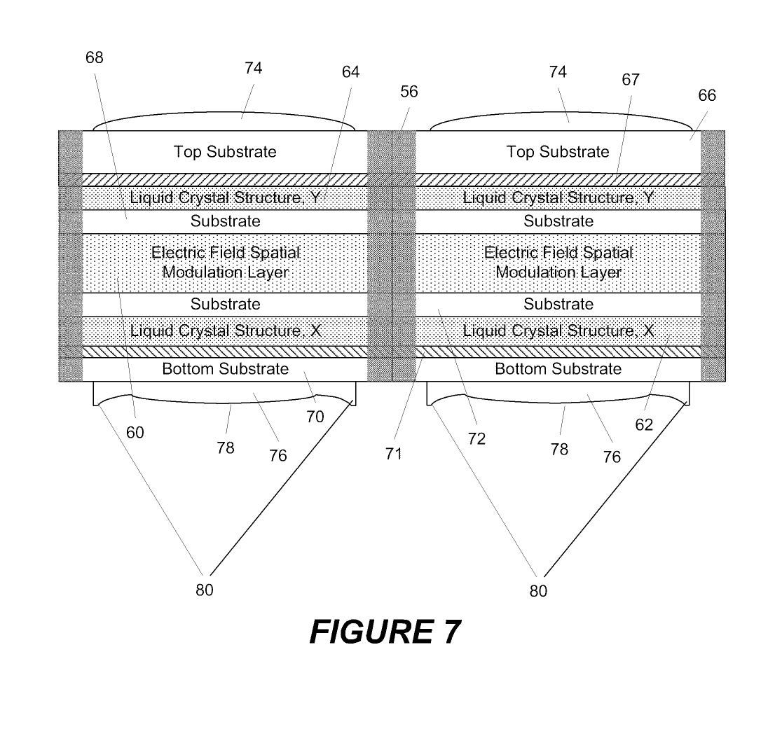

FIG. 7 shows an additional embodiment, similar to that of FIG. 3, in which an electric field modulation layer 60 is centrally located in the wafer structure between liquid crystal structure “X” 62 and liquid crystal structure “Y” 64. Liquid crystal structure Y is supported between top substrate 66 (which has an electrode coating 67) and substrate 68. Similarly, liquid crystal structure X is supported between bottom substrate 70 (which has an electrode coating 71) and substrate 72. The two liquid crystal structures 62, 64 may be of different configurations, as desired. In one example, each structure includes a liquid crystal and polymer network which together establish a desired spatial distribution of the liquid crystal molecules. The liquid crystal structures may also be liquid crystal layers supported by various substrates and spacers, and may interact with separate frequency-dependent permittivity layers or even frequency-dependent permittivity materials incorporated into the liquid crystal structure. The different electrode layers may also be planar or patterned as may be desired for different applications. Those skilled in the art will understand that the desired functionality of the liquid crystal devices will dictate the manner in which the liquid crystal layers, the supporting substrates, the electrodes and any dielectric materials will be arranged.

As with the embodiment of FIG. 3, the FIG. 7 embodiment includes discrete components affixed to the wafer-level structure prior to singulation. In the embodiment shown, fixed lenses 74 are located adjacent to the top substrate. In addition, adjacent to the bottom substrate are located fixed lens/standoff components 76. These components each have a central region 78 that operates as a fixed lens relative to the finished liquid crystal device. In addition, these components have integral standoffs 80 that serve as supports for the finished components relative to any structure to which they are mounted. Such a shape may be useful for securing the liquid crystal device to such as structure and/or for providing a spacing of the optical components relative thereto.

As with the foregoing embodiments, the configuration of FIG. 7 includes regions 56 where the wafer structure will be cut to singulate the individual devices. This embodiment is shown as having two liquid crystal structures with crossed orientations, but an extension of this embodiment could make use of two wafer-level structures such as that shown placed at different rotational orientations so as to apply equally to perpendicular polarizations of light. In such a case, the two structures might be bonded together at the bottom substrate of each, with external components such as the lens structures shown in the figure secured to one or both of the top substrates 66 of the wafer-level structures.

As will be appreciated, a combination of further substrates having embedded liquid crystal optical devices can provide for zoom control, iris control, beam steering, etc. It will also be appreciated that when an embedded liquid crystal lens is used with an imaging system, the embedded liquid crystal optical device can be a fixed or tunable lens designed to have imaging properties to complement other optical components of the imaging system to reduce aberration in the imaging system. The optical properties of the liquid crystal lens can be adjusted to meet the needs of the imaging system and compensate for defects in lens components or spacing between components.

It should be noted that, using a wafer-level fabrication as described herein, the individual layers may be very thin. This is true for any of the foregoing embodiments, but may be better understood with reference to FIG. 7. In an embodiment such as this, a fully functional device may be constructed using outer substrate layers (e.g., substrates 66, 70) each with a thickness on the order of 50-100 μm, inner substrate layers (e.g., substrates 68, 72) each with a thickness on the order of 40-50 μm and liquid crystal structures on the order of 5-30 μm. One version of the FIG. 7 embodiment uses a modulation layer 60 that is made up of a hole patterned electrode that is a coating of indium tin oxide (ITO) having a thickness of 10-50 nm, and a layer of a frequency dependent permittivity material (such as titanium oxide) having a thickness of about 10 nm. Additional layers of the structure, such as alignment layers of 20-40 nm thickness and electrodes of 10-50 nm thickness do not add much to the overall size of the structure. Thus, a device such as that shown in FIG. 7 may have a wafer-level component structure on the order of about 200 μm to 400 μm thick. If the wafer-level component structure consists of two structures like that of FIG. 7, the total thickness would therefore be on the order of 400-800 μm. The dimensions of the added discrete components increase the thickness of the final device, but the base wafer-level component structure is very thin.

After wafer-level fabrication of the liquid crystal devices, including the addition of the discrete components, the next step involves singulating the devices from the wafer. Typically this will be a scribe and break process, a mechanical dicing process, or an optical dicing process. In a scribe and break process, a linear defect (the scribe line) is formed in the wafer and then the wafer is stressed until the wafer fractures along the linear defect. For mechanical dicing, an abrasive wheel is used to remove a strip of material which separates a part of the wafer. In an optical dicing process, a laser is used to remove a strip of material to separate the wafer. FIGS. 3-7 show schematically the regions 56 of the wafers around the individual devices to be removed during singulation.

The finished TLCL can then be packaged by making contact to wires, lead frames, or flexible circuits. Typically a conductive adhesive or solder is used to make this connection. After making the connections, the area around the perimeter of the TLCL is filled with an encapsulating material which protects the TLCL from harsh environments and mechanical abuse.

As will be appreciated, each half TLCL has its orientation layer aligning the liquid crystal molecules in one direction. The electric field modulation of the liquid crystal layer creates a spatial variation in index of refraction for light polarized in one direction. Light polarized in the orthogonal direction sees a uniform index of refraction. By combining both polarization directions close to one another in a sandwich configuration, the lens operates efficiently on unpolarized light.

The production of complete optoelectronic devices during a wafer-level fabrication stage (i.e., prior to singulation) provides significant advantages over the prior art. The size and stability of the wafer as a substrate simplifies the step of affixing external components to the wafer-level component structure. The process of singulation then yields devices which are complete with the exception of such finishing steps such as lead attachment. As such, the present invention provides a simpler and more efficient means of device manufacture.

What is claimed is:

1-30. (canceled)

31. A method of making a plurality of liquid crystal optical devices comprising: fabricating a layered, wafer-level component structure comprising a liquid crystal layer and a plurality of electrode layers for applying an electric field to the liquid crystal layer; affixing each of a plurality of optical components to a surface of the component structure in a different, predetermined location of the surface; and
separating predetermined regions of the component structure so as to singulate said plurality of optical devices therefrom, each of said optical devices comprising a portion of the wafer-level fabricated structure and at least one of the optical components affixed thereto.

32. A method according to claim 31, wherein the plurality of optical components comprises a plurality of lenses.

33. A method according to claim 31, wherein the plurality of optical components comprises a plurality of image sensors.

34. A method according to claim 31, wherein the surface of the component structure is a first surface and wherein the method further comprises affixing a plurality of optical components to a second surface of the component structure different from the first surface, and wherein the step of separating predetermined regions of the component structure singulates a plurality of optical devices each comprising a portion of the wafer-level fabricated structure and at least one of the optical components on each of the first and second surfaces.

35. A method according to claim 34, wherein the optical components on the first surface comprise lenses and wherein the optical components on the second surface comprise image sensors.

36. A method according to claim 31, wherein the liquid crystal layer operates as a lens.

37. A method according to claim 31, wherein the liquid crystal layer operates as a shutter.

38. A method according to claim 31, wherein the liquid crystal layer operates as a diaphragm.

39. A method according to claim 31, wherein the wafer-level component structure includes at least two liquid crystal layers, each with liquid crystal molecules having a different alignment angle.

40. A method according to claim 31, wherein the wafer-level component structure includes a plurality of individually controllable liquid crystal devices each having at least one liquid crystal layer and an electrode layer for applying an electric field to the liquid crystal layer.

41. A liquid crystal optical device produced by a fabrication method comprising the steps of: fabricating a layered, wafer-level component structure comprising a liquid crystal layer and a plurality of electrode layers for applying an electric field to the liquid crystal layer; affixing an optical component to a surface of the component structure in a predetermined location of the surface; and separating predetermined regions of the component structure so as to singulate said optical device therefrom, the optical device comprising a portion of the wafer-level fabricated structure and said optical component affixed thereto.

42. A liquid crystal optical device according to claim 41, wherein the optical component comprises a fixed lens.

43. A liquid crystal optical device according to claim 41, wherein the optical component comprises an image sensor.

44. A liquid crystal optical device according to claim 41, wherein the surface of the component structure is a first surface and wherein the method further comprises affixing an optical component to a second surface of the component structure different from the first surface, and wherein the step of separating predetermined regions of the component structure singulates said optical device such that it comprises a portion of the wafer-level fabricated structure and the optical components on each of the first and second surfaces.

45. A liquid crystal optical device according to claim 44, wherein the optical component on the first surface comprises a lens and wherein the optical component on the second surface comprises an image sensor.

46. A liquid crystal optical device according to claim 41, wherein the liquid crystal layer operates as a lens.

47. A liquid crystal optical device according to claim 41, wherein the liquid crystal layer operates as a shutter.

48. A liquid crystal optical device according to claim 41, wherein the liquid crystal layer operates as a diaphragm.

49. A liquid crystal optical device according to claim 41, wherein the wafer-level component structure includes at least two liquid crystal layers, each with liquid crystal molecules having a different alignment angle.

50. A liquid crystal optical device according to claim 41, wherein the wafer-level component structure includes a plurality of individually controllable liquid crystal devices each having at least one liquid crystal layer and an electrode layer for applying an electric field to the liquid crystal layer.

51. A liquid crystal optical device array comprising:
a layered, wafer-level component structure comprising a liquid crystal layer and a plurality of electrode layers for applying an electric field to the liquid crystal layer; and a plurality of optical components each affixed to a surface of the component structure in a different, predetermined location of the surface such that predetermined regions of the component structure may be separated so as to singulate a plurality of optical devices therefrom, each of said optical devices comprising a portion of the wafer-level fabricated structure and at least one of the optical components affixed thereto.

52. A liquid crystal optical device array according to claim 51, wherein the plurality of optical components comprises a plurality of lenses.

53. A liquid crystal optical device array according to claim 51, wherein the plurality of optical components comprises a plurality of image sensors.

54. A liquid crystal optical device array according to claim 51, wherein the surface of the component structure is a first surface and wherein the component structure further comprises a second surface different from the first surface to which a plurality of optical components are affixed such that singulating the plurality of optical devices results in said devices each including a portion of the wafer-level fabricated structure and at least one of the optical components on each of the first and second surfaces.

55. A liquid crystal optical device array according to claim 54, wherein the optical components on the first surface comprise lenses and wherein the optical components on the second surface comprise image sensors.

56. A liquid crystal optical device array according to claim 51, wherein the liquid crystal layer operates as a lens.

57. A liquid crystal optical device array according to claim 51, wherein the liquid crystal layer operates as a shutter.

58. A liquid crystal optical device array according to claim 51, wherein the liquid crystal layer operates as a diaphragm.

59. A liquid crystal optical device array according to claim 51, wherein the wafer-level component structure includes at least two liquid crystal layers, each with liquid crystal molecules having a different alignment angle.

60. A liquid crystal optical device array according to claim 51, wherein the wafer-level component structure includes a plurality of individually controllable liquid.
